(19) United States
(12) Patent Application Publication
(10) Pub. No.: US 2020/0147928 A1
(43) Pub. Date: May 14, 2020

(54) HARD PLATE

(71) Applicant: FOSHAN NANHAI HUANGGANG METAL PRODUCTS CO., LTD., Foshan (CN)

(72) Inventor: Yin-Chuan WANG, New Taipei (TW)

(21) Appl. No.: 16/191,389

(22) Filed: Nov. 14, 2018

(51) Int. Cl. B32B 15/04; B32B 15/20

(52) U.S. Cl. CPC B32B 15/043; B32B 15/20; B32B 2250/03; C22F 1/04; B32B 2457/00; B32B 2255/06; B32B 2255/20; B32B 2250/40

(57) ABSTRACT

A hard plate formed by three layers of metal sheets is revealed. The three layers of metal sheets include a first metal sheet used as a middle layer, a second metal sheet and a third metal sheet connected to two opposite surfaces of the first metal sheet respectively. The first metal sheet is a 6-8 series aluminum alloy sheet or magnesium alloy sheet processed by high temperature T4 heat treatment while the second metal sheet and the third metal sheet are 1-5 series aluminum alloy sheets processed by high temperature T4 heat treatment. A surface of an outer side of the second metal sheet and the third metal sheet is provided with a metal oxide layer respectively. The hard plate is easy to be processed and able to be colored. Thus the hard plate can be applied to production of electronic housing and other products made by stamping.

### BACKGROUND OF THE INVENTION

### Field of the Invention

The present invention relates to a clad metal plate in metal material field, especially to a hard plate with three-layer structure.

### Description of Related Art

Nowadays electronic products have compact and lightweight design. The electronic products also need to have sufficient mechanical strength. Thus an electronic housing made from metal is the current mainstream. The main metal used for the electronic housing is aluminum alloy. Magnesium aluminum alloy and titanium alloy are also commonly used.

During conventional processes, aluminum alloy is extruded into a substrate/or treated by die-casting and then is produced into a housing of the electronic by mechanical cutting. Lastly the housing is processed by anodizing to get the final product required. The extrusion process can't be applied to producing thin metal sheet or strip materials. The extrusion products can only be turned to have thin-walled shells after much mechanical processing and the production processes are complicated. Die-casting products needs a large amount of mechanical processing work. The die-casting scraps are easily oxidized and containing a lot of impurities. Many manufacturing defects occur during the die-casting process. Thus the production cost is increased.

In order to solve the problems related to the housing produced by extrusion or die-casting, thin metal sheets or metal strips are processed by stamping to produce the housing of the electronic quickly. The housing is further treated by mechanical processing, grinding, sand blasting, and polishing to get the compact final product. The most commonly used 6-8 series aluminum alloy foil or strip will become hard rolled/sheet material after being processed by high temperature T4 heat treatment while the hard rolled/sheet material obtained is difficult to be processed by stamping.

### SUMMARY OF THE INVENTION

Therefore it is a primary object of the present invention to provide a hard plate that is easy to be processed and having sufficient mechanical strength.

In order to achieve the above object, a hard plate according to the present invention is composed of three layers of metal sheets connected to each other. The three layers of metal sheets include a first metal sheet used as a middle layer, a second metal sheet and a third metal sheet connected to a first surface and a second surface of the first metal sheet respectively. The first surface and the second surface of the first metal sheet are opposite to each other. The first metal sheet is a 6-8 series aluminum alloy sheet or magnesium alloy sheet processed by high temperature T4 heat treatment while the second metal sheet and the third metal sheet are 1-5 series aluminum alloy sheets processed by high temperature T4 heat treatment. A metal oxide layer is arranged at a surface on an outer side of the second metal sheet and a surface on an outer side of the third metal sheet respectively, forming an outer surface of the hard plate. The total thickness of the second metal sheet and the third metal sheet is ranging from 10%-90% of the thickness of the hard plate while the thickness of the first metal sheet is 90%-10% of the thickness of the hard plate.

Preferably, the temperature of T4 heat treatment of the 6-8 series aluminum alloy sheet is 440° C.-660° C. and the temperature of T4 heat treatment of the 1-5 series aluminum alloy sheet is 450° C.-650° C.

The hard plate of the present invention has the advantages that the first metal sheet is easy to be processed, shaped and having sufficient mechanical strength. The first metal sheet is formed by soft 6-8 series aluminum alloy sheet or magnesium alloy sheet and further processed by high temperature T4 heat treatment. After T4 heat treatment, the second metal sheet and the third metal sheet formed by 1-5 series aluminum alloy sheet become soft and flexible, easy to be shaped or bent by stamping. The present invention uses different ratios/combinations of these two featured aluminum alloy materials to produce the hard plate that is not only having multiple functions and sufficient mechanical strength but also easy to be processed. Moreover, the 1-5 series aluminum alloy used as an outer layer of the hard plate can be treated by anodizing and the following coloring processes for aesthetics. As to the 6-8 series aluminum alloy sheet or magnesium alloy used as the middle layer, it is for solving the problems of anodized aluminum sheets such as insufficient compressive strength, tensile strength, and yield strength.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment according to the present invention;

FIG. 2 is a sectional view of an embodiment according to the present invention.

### DETAILED DESCRIPTION OF THE PREFERRED EMBODIMENT

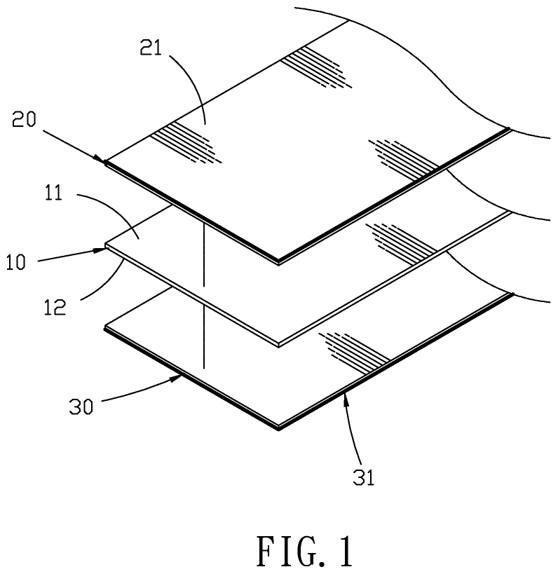

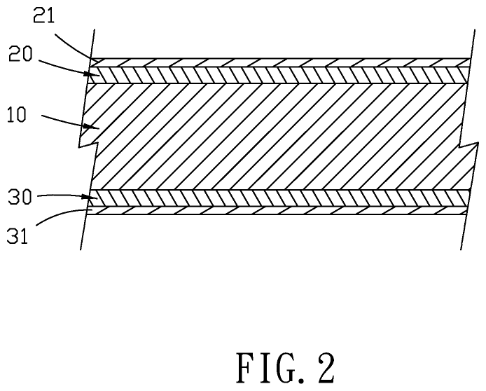

Refer to FIG. 1 and FIG. 2 an explosive view and a sectional view of an embodiment according to the present invention are revealed.

In a preferred embodiment of the present invention, a hard plate includes three layers of metal sheets connected to each other. A first metal sheet 10 is used as a middle layer while a second metal sheet 20 connected to a first surface 11 of the first metal sheet 10 and a third metal sheet 30 connected to a second surface 12 of the first metal sheet 10. The first surface 11 and the second surface 12 of the first metal sheet 10 are opposite to each other. The first metal sheet 10 is a 6-8 series aluminum alloy sheet or magnesium alloy sheet processed by high temperature T4 heat treatment while the second metal sheet 20 and the third metal sheet 30 are 1-5 series aluminum alloy sheets processed by high temperature T4 heat treatment. A metal oxide layer 21, 31 is disposed on a surface at an outer side of the second metal sheet 20 and a surface at an outer side of the third metal sheet 30 respectively, forming an outer surface of the hard plate. The total thickness of the second metal sheet 20 and the third metal sheet 30 is ranging from 10%-90% of the thickness of the hard plate while the thickness of the first metal sheet 10 is 90%-10% of the thickness of the hard plate.

In a preferred embodiment of the present invention, the temperature of T4 heat treatment of the 6-8 series aluminum alloy sheet is 440° C.-660° C. and the temperature of T4 heat treatment of the 1-5 series aluminum alloy sheet is 450° C.-650° C. After heating and rolling processes (without interface additive), the first metal sheet 10, the second metal sheet 20 and the third metal sheet 30 form the hard plate of the present invention.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A hard plate comprising:
a first metal sheet used as a middle layer; and
a second metal sheet and a third metal sheet that are connected to a first surface of the first metal sheet and a second surface opposite to the first surface of the first metal sheet respectively;
wherein the first metal sheet is a 6-8 series aluminum alloy sheet or magnesium alloy sheet processed by high temperature T4 heat treatment; the second metal sheet and the third metal sheet are 1-5 series aluminum alloy sheets processed by high temperature T4 heat treatment; the second metal sheet and the third metal sheet that form an outer surface of the hard plate respectively are provided with a metal oxide layer respectively; the total thickness of the second metal sheet and the third metal sheet is ranging from 10%-90% of the thickness of the hard plate while the thickness of the first metal sheet is 90%-10% of the thickness of the hard plate.

2. The hard plate as claimed in claim 1, wherein the temperature of T4 heat treatment of the 6-8 series aluminum alloy sheet is 440° C.-660° C. and the temperature of T4 heat treatment of the 1-5 series aluminum alloy sheet is 450° C.-650° C.
